(19) United States
(12) Patent Application Publication
(10) Pub. No.: US 2025/0310347 A1
(43) Pub. Date: Oct. 2, 2025

(54) NON-TRANSITORY MACHINE-READABLE STORAGE MEDIUM, METHOD AND APPARATUS FOR DEVICE SECURITY

(71) Applicants: Vinupama GODAVARTHI, Folsom, CA (US); Venkat GOKULRANGAN, Portland, OR (US); Julien CARRENO, Glounthaune (IE); Nivedita AGGARWAL, Portland, OR (US); Ankur N. SHAH, Folsom, CA (US)

(72) Inventors: Vinupama GODAVARTHI, Folsom, CA (US); Venkat GOKULRANGAN, Portland, OR (US); Julien CARRENO, Glounthaune (IE); Nivedita AGGARWAL, Portland, OR (US); Ankur N. SHAH, Folsom, CA (US)

(21) Appl. No.: 19/233,084

(22) Filed: Jun. 10, 2025

(51) Int. Cl. H04L 9/40; G06F 9/54

(52) U.S. Cl. CPC H04L 63/105; G06F 9/545; G06F 2209/544

(57) ABSTRACT

Provided is a computer-readable medium including computer-readable instructions. When the instructions are executed by a computer, the computer may implement a method. According to this method, a configuration operation on a target resource is requested by a non-secure domain. Furthermore, the configuration operation on the target resource is performed upon determining that the configuration operation requested by the non-secure domain is permissible, where the secure domain is configured such that the resource protected by the secure domain is free from attacks by an agent external to the trusted driver module.

### BACKGROUND

Confidential Computing (CC) technologies, such as Trusted Execution Environment (TEE) Device Interface Security Protocol (TDISP) and Trust Domain Extensions (TDX)/TDX Connect, represent industry standards for providing hardware-based isolation in data centers and cloud environments. These solutions enable sensitive workloads, including AI, to run in hardware-isolated virtual machines, such as confidential VMs, that utilize I/O devices, many of which are built on Peripheral Component Interconnect Express (PCIe) Single Root Input/Output Virtualization (SRIOV). CC may provide full hardware-based isolation, offering robust protection against unauthorized access and tampering. However, the implementation CC demands significant silicon investments and has a long development timeline.

### BRIEF DESCRIPTION OF THE FIGURES

Some examples of apparatuses and/or methods will be described in the following by way of example only, and with reference to the accompanying figures, in which

FIG. 1 illustrates a block diagram of a system 100 including a plurality of security-related components configured for security in operating system (OS);

FIG. 2 illustrates a flow chart of method 200 performing configuration operation of an example of the application.

FIG. 3 illustrates a flow chart of method 300 performing configuration operation of an example of the application;

FIG. 4 illustrates a flow chart of method 400 performing configuration operation of an example of the application;

FIG. 5 illustrates a block diagram of system 500 comprising a plurality of security-related components configured for security of an example of the application; and

FIG. 6 illustrates a block diagram of apparatus 600 of an example of the application.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures identical or similar reference numerals refer to identical or similar elements and/or features, which may be identical or implemented in a modified form while providing the identical or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the identical combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the identical function. If a function is described below as implemented using multiple elements, further examples may implement the identical function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage medium accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the identical or different examples. Furthermore, the terms “comprising,” “including,” “having,” and the like, as used with respect to examples of the present disclosure, are synonymous.

In some examples, an interim solution is provided to achieve isolation through software security mechanisms layered on top of existing accelerator I/O virtualization capabilities. This interim solution provides a simpler and more accessible steppingstone while paving the way for more complex, long-term CC solutions.

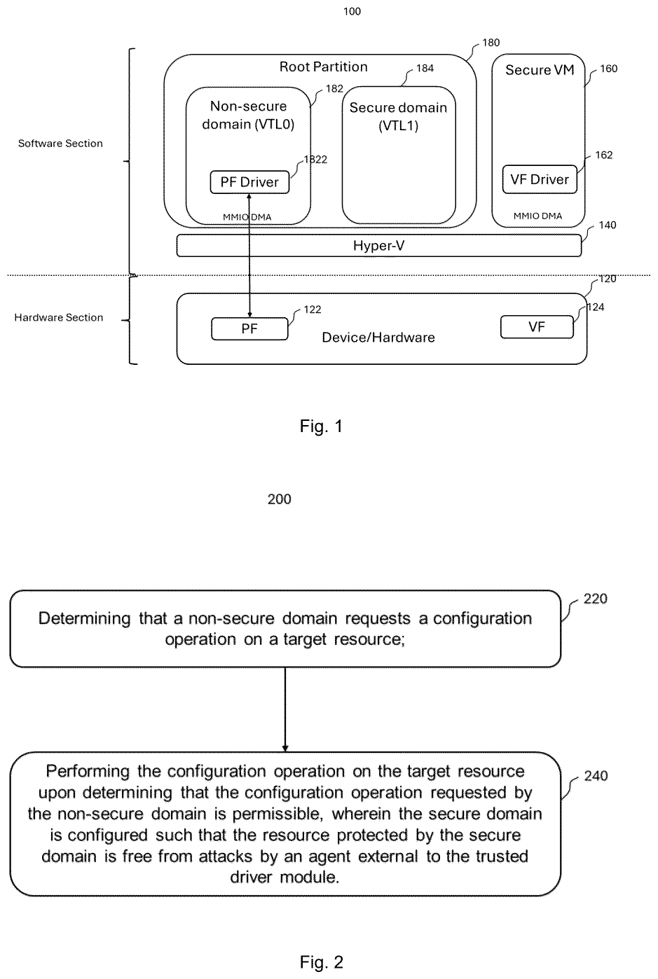

FIG. 1 illustrates a system 100 including a plurality of security-related components configured for security in operating system (OS). In particular, FIG. 1 illustrates a hardware section and a software section. The hardware section includes a device 120 including an untrusted physical function (PF) module 122 and a trusted virtual function (VF) module 124. The software section includes a hypervisor 140, a secure virtual machine (VM) 160, and a root partition 180. The hypervisor 140 is a trusted entity in FIG. 1. The root partition 180 includes a non-secure domain 182, corresponding to Virtual Trust Level 0 (VTL0), including an untrusted PF driver module 1822 and a secure domain 184, corresponding to Virtual Trust Level 0 (VTL1). The security VM 160 is a trusted entity including a trusted VF driver module 162. A partition may be a low-level, statically-isolated execution environment often used in secure or embedded systems. A VM may be a fully virtualized system designed to run general-purpose OSes with dynamic resource control. Being trusted or untrusted may be in the context of or in respect to security. Being trusted or untrusted may mean being secure or non-secure. The operating system may be Windows or one of other systems like Android and MacOS. The PF module, PF Driver module, VF module and VF Driver module may respectively refer to as PF, PF Driver, VF and VF Driver.

The PF Driver 1822 may be a software driver located in the root partition and its role may include some or all of device initialization, device configuration, single root input/output virtualization (SR-IOV) management, and teardown/reset. The device initialization may refer to setting up the device during boot or VM creation, the device configuration may refer to configuring Memory Mapped I/O (MMIO) regions, Direct Memory Access (DMA), Base Address Registers (BARs). The SR-IOV management may refer to enumerating and configuring Virtual Functions (VFs), and the teardown/reset may refer to deallocating or resetting resources during VM destruction. The PF module 122 may be a component of a PCIe device, exposing management interfaces and the functionalities of the device. In some examples, the PF module 122 may expose some privileged features of the device that can be accessed by PF and are not available to VFs. The privileged features may include features associated with device configuration space access, SR-IOV management and DMA engine configuration. The PF driver 1822 is configured to control the PF module 122 and configure the device 120. In some examples, the device 120 may refer to a graphic processing unit (GPU) and/or a neural processing unit (NPU).

The VF driver 162 may be a software driver located in the secure VM 160 and its role includes workload submission, command and data I/O, and non-privileged configuration. The workload submission may refer to sending workloads to the VF 124 for processing. The command and data I/O may refer to performing device-specific interactions through VF interfaces. The non-privileged configuration may mean that VF driver 162 does not configure the device, and it operates only within the bounds set up by the PF 122. The VF module 124 may be a hardware-exposed virtualized interface that is derived from the PF 122, offering a subset of functionality to a VM. The VF driver 162 is a software client running in a VM that interacts with its assigned VF 124. The VF driver 162 may communicate directly with the VF module 124 to perform device operations but cannot configure and/or reconfigure hardware or access PF-level functions.

In some examples, while technologies such as Virtualization Technology for x86 (VT-x), Virtualization Technology for Directed I/O (VT-d), Virtualization Technology for Redirect Protection (VT-rp), and Virtualization-Based Security (VBS) may ensure memory isolation via mechanisms like Extended Page Tables (EPT) and Second Level Address Translation (SLAT), the Physical Function (PF) driver's privileged access remains a security concern. This access exposes the device to potential attacks, including spoofing, hijacking, and confused deputy attacks. These vulnerabilities arise because the PF driver, despite not being part of the Trusted Computing Base (TCB), retains complete access to critical device functions.

In some examples, PF module 122 in FIG. 1, which should be untrusted, may be trusted in some scenarios because the SR-IOV specification is designed with the expectation that the PF module 122 is trusted, which means the PF 122 may have privileged access to the device. Trusting the PF module 122 may violate some requirements for protecting some workloads or tasks, such as workloads associated with an AI model, where high or complete isolation from most or all host components is demanded.

In some examples, the implementation of the standard PCIe SR-IOV specifications, having no hardware support for TDISP in the IP and SoC, in accelerators in some current platforms cannot satisfy the isolation requirements. It is because that SR-IOV assumes that a PF driver is trusted, which means that the PF driver has privileged access to the devices that is to be protected. This privilege of the PF drivers violates the fundamental requirement for some protections, such as AI model protections, that requires complete or high isolation from all host components including the PF driver.

In order to solve the problem presented above, a new solution is provided in some examples. The solution may create a software-protected secure version of the hardware-based TDISP solution. It may protect AI and other sensitive workloads that process high-value assets. To address the security risk posed by the privileged access of the Physical Function (PF) driver to SR-IOV devices, the new solution introduces a novel driver architecture by refactoring a monolithic PF driver into two components: one operating in a highly secure, trusted host (VTL1) and the other in an untrusted, lower-privileged host (VTL0). This split design May disallow access form untrusted and/or unprivileged entities, and downgrade or de-privileged job submissions from VTL0, thereby protecting sensitive assets and enhancing the security of workload execution.

This solution is time-to-market (TTM) and leverages software constructs to enable secure deployment on AI and other data processing accelerators that support standard SR-IOV, without requiring significant hardware changes. It may empower operating system vendors (OSVs) and independent software vendors (ISVs) to protect their AI models and ensure the integrity of associated data. By avoiding or reducing the need for complex silicon-based implementations, this approach may allow hardware vendors to deliver secure solutions more efficiently. Additionally, it may open opportunities for monetization through enhanced security offerings in areas such as AI and gaming.

FIG. 2 illustrates a method 200 performing configuration operation of an example of the application. The method 200 may be implemented when a machine executes some machine-readable instructions stored in a non-transitory medium. In a specific example, executing the machine-readable instructions may cause the machine to implement a trusted driver module in a secure domain, where method 200 is implemented by the trusted driver module.

The method 200 may include determining 220 that a non-secure domain requests a configuration operation on a target resource; and performing 240 the configuration operation on the target resource upon determining that the configuration operation requested by the non-secure domain is permissible, wherein the secure domain is configured such that the resource protected by the secure domain is free from attacks by an agent external to the trusted driver module. The configuration operation requested by the non-secure domain is not directly performed. Instead, operations are performed to determine whether the requested configuration operation is permissible. Based on this permission check, impermissible configuration operation cannot be made to the target resource, such that the target resource is protected from some risks associated with some untrusted modules, such as the PF module, having high privileges in some special situations. The agent external to the trusted driver module may be one or more modules reside in the non-secure domain, such as a PF driver, a VF driver, an application and so on.

In some examples, the trusted driver module may be configured to identify the target resource as protected based on information retrieved from a firmware table. In firmware table may include a list of protected target resources. In some other examples, the trusted driver module may be configured to identify any target resource located in the secure domain as protected.

In some examples, the secure domain comprises or is a secure kernel hosting a trusted driver component and the non-secure domain comprises or is an operating system kernel hosting one or more untrusted driver modules.

The target resource may be a device like a GPU, a NPU or another hardware device, or a function or a module of the device. The module may be a hardware module, a software module, or a module mixed with a hardware portion and a software portion.

In a specific example of performing 240 the configuration operation on the target resource, the trusted driver module may be configured to determine that the configuration operation is requested by an untrusted driver module in the non-secure domain. For example, the trusted driver module may receive a request originated or forwarded from the untrusted driver module in the non-secure domain. The request may include some information indicating that the untrusted driver module is not secure, where the information may either include information directly indicating that the untrusted driver module is non-secure, or indirectly indicate the untrusted driver module to be non-secure by indicating the whole untrusted domain is not secure.

In order to perform 240 the configuration operation, the trusted driver module may be further configured to perform the configuration operation as a proxy for the untrusted driver module in the non-secure domain. The proxy may mean that the trusted driver module performs the configuration operation on the target resource as if the configuration operation is originally requested by the trusted driver module in the secure domain, rather than by an untrusted domain or a specific untrusted module in the non-secure domain. Based on this proxy mechanism, it seems that no request from an untrusted module or non-secure domain may be directly permitted, giving no exception to any untrusted module, and therefore improving the security of the secure domain or the target resource protected by the security domain. In a specific example of the proxy mechanism, the trusted driver is configured to perform the configuration operation as if it were an original requester of the configuration operation. In an alternative example of the proxy mechanism, the trusted driver is configured to perform the configuration operation as if the configuration operation is requested by another trusted module.

In some examples, the trusted driver module is configured to directly make a determination on whether the configuration operation on the target resource is permissible. In some other examples, another trusted module located in the secure domain make the determination and the trusted driver module is configured to obtain a result of the determination from the trusted module making the determination.

No matter which module makes the determination, the determination may be based on at least one of an identification of an entity residing in the non-secure domain and requesting the configuration operation, a type of the target resource, a type of the configuration operation, or a current state of the target resource. Some examples of the type of target resource may include GPU hardware resources such as MMIO registers, DMA channels, PCIe configuration spaces. Some examples of the type of configuration operation may include setting up the target resource, tearing down of the target resource and modification of parameters of the target resource. Setting up the target resource may include configuring and allocating a function on the device to a particular VM or partition, or setting up a function or a module of a device. Tearing down the target resource may include deallocating or removing that function or module. Modifying a parameter of the target resource may include modifying a parameter of the function or module. Some examples of the current state may include unassigned, assigned, error and degraded.

In some examples, the trusted driver module is configured to determine whether the configuration operation requested by the non-secure domain is permissible. If the requested configuration operation is not permissible, the trusted driver module is configured to deny the configuration operation.

In some examples, before determining 220 that a non-secure domain requests a configuration operation on a target resource, the trusted driver module is configured to perform the operation of receiving a request for the configuration operation from the untrusted driver module in the non-secure domain. Operation 220 may be performed based on the request received. The transmission of the request from the untrusted driver module to the trusted driver module may be via a privileged path. The privileged path may be a secure, controlled communication route that allows an untrusted module, such as an untrusted driver operating in a non-secure domain, to request sensitive configuration operations without directly accessing critical hardware. Instead of executing configuration operations itself, the untrusted driver module sends the request through a secure channel to a trusted driver module, such as the Physical Function Driver Companion (PF DC) in FIG. 4. This trusted driver module may act as a gatekeeper, validating and executing the operation only if it is permissible under security policies. Enforcement is achieved through both software like secure driver structures and hardware protections like trapping unauthorized accesses via Extended Page Tables. Thus, the privileged path achieves that even if a non-secure domain initiates an action, only a secure, trusted agent actually performs the sensitive operation, preserving device security. In addition to the privileged path, there is also a path referred to as the de-privileged path. The de-privileged path may restrict what the non-secure domain can access, minimizing the risk of misbehavior by limiting exposure. Instead of providing the untrusted driver module access to full physical function (PF) capabilities of the device, the system presents only a downgraded interface, typically a virtual function (VF), that offers limited, safer operational capabilities. This restriction is enforced during the initial setup of the device, ensuring that untrusted code can only interact with non-critical resources and cannot even attempt privileged operations without escalating through the secure path. In this model, trust is built into the system by controlling visibility and permission at the exposure level, reducing the system's attack surface and ensuring that only appropriately privileged domains manage sensitive device functions.

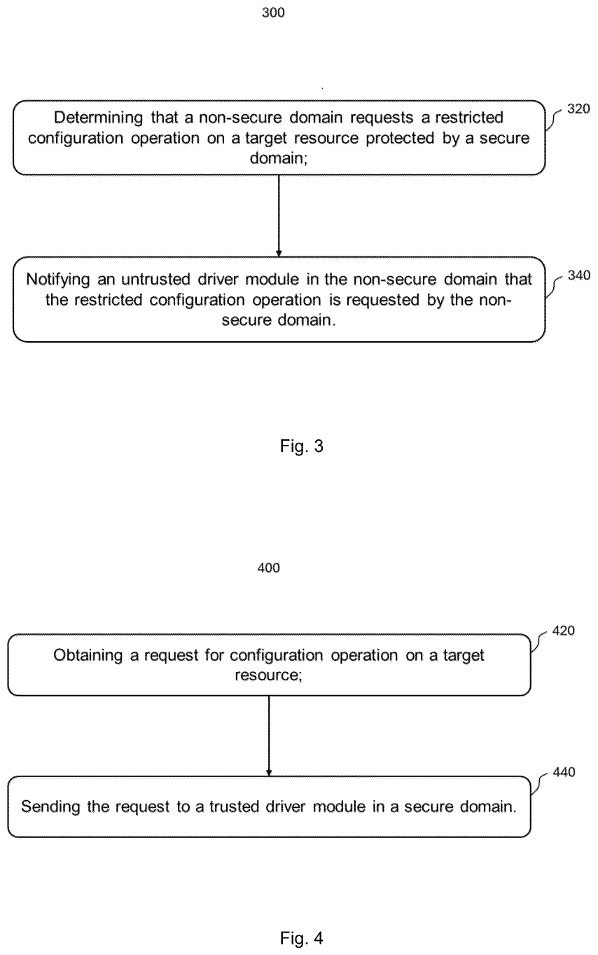

FIG. 3 illustrates a method 300 performing configuration operation of an example of the application. The method 300 may be implemented when a machine executes some machine-readable instructions stored in a non-transitory medium. In a specific example, executing the machine-readable instructions may cause the machine to implement controlling module, where method 300 is implemented by the controlling module.

The method 300 may include determining 320 that a non-secure domain requests a restricted configuration operation on a target resource protected by a secure domain; and notifying 340 an untrusted driver module in the non-secure domain that the restricted configuration operation is requested by the non-secure domain.

In some example, whether a configuration operation is restricted may be determined based on a policy restricting the configuration operation on the target resource. The policy may be implemented by withholding a valid physical address of the target resource required to perform the configuration operation. When a valid physical address of a target resource that a configuration operation is directed to is withheld by the policy, the configuration operation is restricted by the policy and the configuration operation is a restricted configuration operation. In some examples, when a physical address of a target resource cannot be found for implementing a configuration operation to the target resource due to the restriction by the policy, the configuration operation may be considered restricted.

The controlling module may be configured to perform the operation of receiving a request for the configuration operation on the target resource from a requesting module in the non-secure domain. The requesting module may be an untrusted module in the non-secure domain. The request for the configuration operation may be sent to the controlling module, so that the controlling module may determine whether the requested configuration operation is restricted. In some examples, the request is received from an untrusted driver module in the non-secure domain, and in some other examples, the request is received from a different type of untrusted module in the non-secure domain. Since the request is from a module in the non-secure domain, it may be treated as a request made by the non-secure domain.

The controlling module may also be configured to operations of receiving a job submission, downgrading the job submission to a de-privileged level, such that the job submission is acceptable in the non-secure domain and is unacceptable in the secure domain; and sending the downgraded job submission to a module in the non-secure domain for execution of the job. The operations associated with job submission make the controlling module and the non-secure domain may implement more functions while preventing the target resources from impermissible configuration operations. The downgraded job submission is not required to and/or is not allowed to pass through secure domain 540, thereby reducing the possibility of impermissible operations to target resources protected by the secure domain.

The controlling module may be a hypervisor, which may be configured to create the secure domain and the non-secure domain. Meanwhile, the controlling module itself may be a trusted or secure entity, rather than an untrusted entity or a non-secure entity. In some other examples, the secure domain and the non-secure domain may be flexibly created and configured by a module or entity other than the controlling module.

FIG. 4 illustrates a method 400 performing configuration operation of an example of the application. The method 400 may be implemented when a machine executes some machine-readable instructions stored in a non-transitory medium. In a specific example, executing the machine-readable instructions may cause the machine to implement an untrusted driver module in a non-secure domain, where method 300 is implemented by the untrusted driver module.

The method 400 may include obtaining 420 a request for configuration operation on a target resource; and sending 440 the request to a trusted driver module in a secure domain.

The untrusted driver module may be further configured to perform operations associated with job submission. The operations may include receiving a job submission, downgrading the job submission to a de-privileged level, such that the job submission is acceptable in the non-secure domain and is unacceptable in the secure domain; and sending the downgraded job submission to an entity in the non-secure domain to execute the job. Although the operations associated with job submission in some examples are implemented by the untrusted driver module, they may be implemented by or cooperate with the controlling module in some other examples.

In some examples, the request for the configuration operation is generated by the untrusted driver module. In some other examples, the request for the configuration operation is generated by a different untrusted module and is received by the untrusted driver module.

The untrusted driver module in the non-secure domain is coupled with the trusted driver module in the secure domain. Therefore, the untrusted driver module is capable of sending the requests for the configuration operations from the non-secure domain to the secure domain. In a specific example, the request is sent via a privileged path.

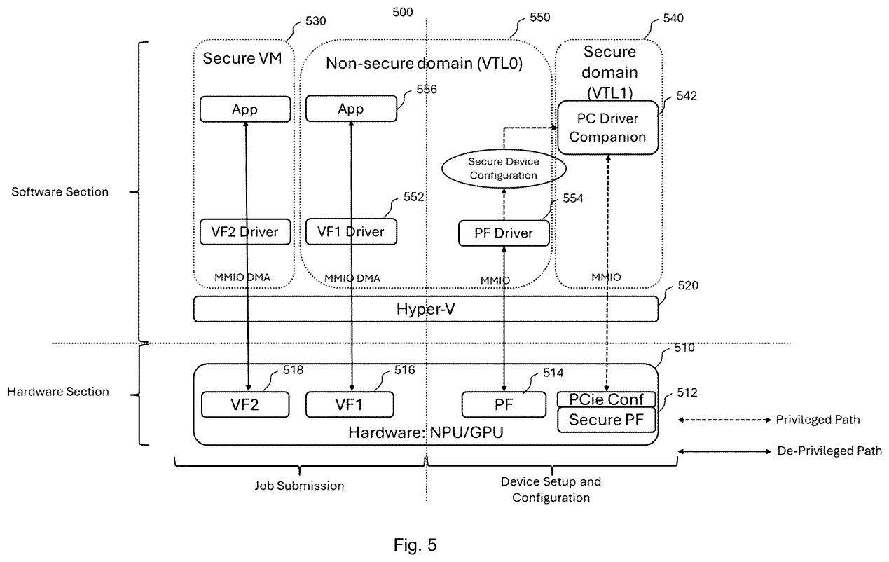

Methods 200, 300 and 400 may be three separate or independent methods, and may also be applied together, such as in a system 500 as illustrated by FIG. 5.

FIG. 5 illustrates a system 500 comprising a plurality of security-related components configured for security of an example of the application. In particular, FIG. 5 includes a hardware section and a software section. The hardware section may include a device 510 that includes two physical function (PF) modules 512 and 514 and two virtual function (VF) modules 516 and 518, consistent with a PCIe SR-IOV-enabled architecture. The software section may include a hypervisor 520, a secure virtual machine (VM) 530, and two isolated execution environments: a secure domain 540 and a non-secure domain 550. Operations of method 200, method 300 and method 400 may be presented based on the system illustrated by FIG. 5.

The hypervisor 520 in FIG. 5 may be a trusted module or entity. It may be a part of the system's Trusted Computing Base (TCB). The secure domain 540 may represent a high-privilege, trusted execution environment, while the non-secure domain 550 may represent a lower-privilege environment that is not part of the TCB. In a specific example, such as an example of a Windows-based platform using Virtualization-Based Security (VBS), the secure domain 540 may correspond to Virtual Trust Level 1 (VTL1) and the non-secure domain may correspond to Virtual Trust Level 0 (VTL0). The hypervisor 520 may be configured to create the secure domain 540 and the non-secure domain 550.

In this architecture, the secure domain 540 may include a PF Driver Companion (PF DC) 542, which may be a trusted software driver. During system boot, secure devices 510 may be identified through the Advanced Configuration and Power Interface (ACPI) Secure Device (SDEV) table. The PF DC 542 may be loaded first in the secure domain 540 as a lower filter driver, gaining exclusive control over secure device configuration. After the PF DC 542 is initialized, a Kernel Mode Driver (KMD) may be loaded in the non-secure domain 550. This boot sequence may be enforced by the system security framework, such as Microsoft Windows Virtualization Based Security (VBS), to maintain a secure initialization process and ensure that device configuration is only performed by trusted components. Microsoft Windows VBS may be a security system or architecture that uses hardware virtualization features to isolate sensitive parts of the operating system, thereby protecting them from attacks, even from compromised kernel-mode drivers.

In the system illustrated by FIG. 5, the non-secure domain 550 may include a VF1 Driver 552, a PF Driver 554 and an application 556. The VF1 driver 552 may be a software driver responsible for interacting with the VF1 module 516 of the device to submit workloads and/or perform command and data I/O operations. The VF1 driver 552 may operate under strict privilege constraints, which means that it may be granted only VF-level access, without the ability to perform any privileged operations such as device configuration, DMA engine setup, or interrupt routing. The PF driver 554 in this architecture may cooperate with PF DC 542 in the secure domain 540 to improve the protection to the device 510.

The device in FIG. 5 may be a GPU, a NPU, or a different device of another type. The device 510 may include two PF modules 512 and 514. One PF module 512 may be associated with the secure domain 540 and may be controlled by and/or communicate with the PF DC 542. It may handle secure configuration, MMIO space management, and DMA setup. The other PF module 514 may be associated with the non-secure domain 550 and may be accessible by the Kernel Mode Driver (KMD) for limited, non-privileged operations as permitted under VF-level access rules.

The two VF modules 516 and 518 in device 510 may be derived from the respective PFs and may be exposed to the secure domain and non-secure domain accordingly. The VF1 module 516 may be exposed to the non-secure domain 550, where it may be used by the KMD, acting as a VF driver 552, to submit workloads and perform data I/O operations. The VF driver 552 may be restricted from accessing any privileged device functionality and may operate strictly within the bounds defined by the PF configuration and SR-IOV constraints. The VF2 module may be exposed to a secure virtual machine (VM) 530, which can be understood as a secure domain. In some examples, the VF2 module 518 may be used for secure workload execution within the secure VM 530, under the enforcement of the secure domain and with policies defined by the PF Driver Companion (PF DC) 542. While the VF2 driver 532 in the secure VM 530 may interact with VF2 518 for workload submission, VF2 518 itself may be a part of a trusted data path for handling secure device interactions that are protected from interference by the non-secure domain.

In some examples of the application, the trusted driver module, the untrusted driver module and the controlling module associated with methods 200, 300 and/or 400 may respectively be the PF DC 542, PF Driver 554 and Hypervisor 520 in FIG. 5. PF DC 542, PF Driver 554 and Hypervisor 520 may implement all functions of the trusted driver module, the untrusted driver module and the controlling module, respectively.

PF Driver 554, an example of the untrusted driver module, may send a request for a configuration operation on a target resource to PF DC 542. The request is from the non-secure domain 550 to the secure domain 540 and is from an untrusted module 554 to a trusted module 542. The request may be generated by PF Driver 554, or be generated by another module outside the secure domain and be forwarded to the PF Driver 554. In some examples, the request may be sent to PF DC 542 via a privileged path as illustrated by FIG. 5.

PF DC 542, an example of the trusted driver module, may determine whether the requested configuration operation on the target resource is permissible. The determination may be based on information retrieved from a firmware table or from another storage unit. Because the request is sent from the non-secure domain, the configuration operation may generally be considered being requested by the non-secure domain 550.

For example, the PF DC 554 may determine whether a target resource is protected or not. In a particular example, every target resource that a request for a configuration operation is directed to is considered protected. In such a situation, the information retrieved from the firmware table by PF DC includes a list of permissible configuration operations. If the requested configuration operation is included in the list of permissible configuration operations, the requested configuration operation is permissible; and if the requested configuration operation is not included in the list of permissible configuration operations, it is not permissible.

In another example, the information retrieved from the firmware table includes identifiers of a plurality of protected devices or resources that are available for some configuration operations requested by a non-secure domain. Based on the identifiers, the PF DC may determine whether the target resource corresponding to a request for a configuration operation is available. If the target resource is not available, the request will be rejected by the PF DC. If the target resource is available, PF DC may further determine whether the requested configuration is permissible based on a list of permissible configuration operations retrieved from the firmware table. If the requested configuration operation is included in the list of permissible configuration operations, the requested configuration operation is permissible; and if the requested configuration operation is not included in the list of permissible configuration operations, it is not permissible.

In an example, the determination on whether a configuration operation on a target resource is permissible may be based on at least one of an identification of an entity residing in the non-secure domain and requesting the configuration operation, a type of the target resource, a type of the configuration operation, or a current state of the target resource.

In another example, every target resource a request for a configuration operation is directed to may be considered to be available to some configuration operations requested by a non-secure domain. In such a situation, the information retrieved from the firmware table by PF DC includes a list of permissible configuration operations. If the requested configuration operation is included in the list of permissible configuration operations, the requested configuration operation is permissible; and if the requested configuration operation is not included in the list of permissible configuration operations, it is not permissible.

In yet another example, the determination on whether a configuration operation on a target resource is permissible may be based on at least one of an identification of an entity residing in the non-secure domain and requesting the configuration operation, a type of the target resource, a type of the configuration operation, or a current state of the target resource. There may be a plurality of alternative rules for making the determination. According to a first rule, when any of some or all of the above plurality of parameters, such as the identification of the entity, the type of the target resource, the type of configuration operation and the current state of the target resource, fails to meet its corresponding requirement, the configuration operation may be impermissible. According to a second rule, a weighted value may be calculated using some or all of the above plurality of parameters, whether the configuration operation is permissible is based on comparison between the calculated weighted value and a threshold value.

The firmware table may be an Advanced Configuration and Power Interface (ACPI) Secure Device (SDEV) table. In a specific example, the PF DC, loaded in the secure domain, e.g., VTL1, reads the ACPI SDEV firmware table. Then it uses the table to identify target resource that are designated as protected. In an example, the firmware table may include device identifiers, security properties, and access requirements. The device identifiers may be Peripheral Component Interconnect (PCI) paths or ACPI paths. The security properties may include whether the device can be assigned to a non-secure domain. The access requirements may include memory isolation via Input-Output Memory Management Unit (IOMMU) and need for firmware-assisted mediation.

Upon that the PF DC 542 determines that a configuration operation on a target resource is permissible, the PF DC 542 may perform the configuration operation on the target resource. For example, the PF DC 542 may perform the configuration operation as a proxy of the non-secure domain 550 or specifically as a proxy of the PF Driver module 554. The proxy may mean that the PF DC 542 performs the configuration operation on the target resource as if the configuration operation is originally requested by the PF DC, which is a trusted module in the secure domain, rather than by an untrusted domain or a specific untrusted module in the untrusted domain. Based on this proxy mechanism, a security logic or principle that no request from an untrusted module or non-secure domain may be permitted is strengthened, improving the security of the secure domain including the target devices, which may be referred to as target resources.

In some examples, the PF DC 542 may directly perform the configuration operation to the target resource. In a more specific example, the PF DC may transfer the request into an instruction for performing the configuration operation and send the instruction to the target resource, forcing the configuration operation to be performed on the target resource. In some other examples, the PF DC 542 may send the request for the configuration operation to the target resource, so that the target resource may determine whether the configuration operation may be performed based on the policy or will of the target resource.

The configuration operation on a target resource may comprise at least one of setting up the target resource, tearing down the target resource, or modifying a parameter of the target resource. The target resource may be a device like a GPU, a NPU or another hardware device, or a function or a module of the device. The module may be a hardware module, a software module, or a module mixed with a hardware portion and a software portion. Setting up the target resource may include configuring and allocating a function on the device to a particular VM or partition, or setting up a function or a module of a device. Tearing down the target resource may include deallocating or removing that function or module. Modifying a parameter of the target resource may include modifying a parameter of the function or module.

In some examples, the hypervisor 520, an example of the controlling module, may receive a request from a module, such as an application module or a VF Driver, in the non-secure domain 550, where the request is for a restricted configuration operation on a target resource 510 protected by the secure domain 540. The term restricted may mean that the configuration operation is not allowed to be made without any authentication or evaluation. The hypervisor 520 may further determine the reception of the request and notify the PF Driver 554 in the non-secure domain 550 that the restricted configuration operation is requested by the non-secure domain 550. When the module originating the request is in the non-secure domain 550, the request may be considered being made by the non-secure domain 550.

A configuration operation may not be treated as restricted by default. Whether the configuration operation is a restricted one may be determined by the hypervisor based on a policy restricting a plurality of configuration operations on the target resource. The policy may be implemented by withholding valid physical addresses of target resources required for performing the restricted configuration operations. For example, if configuration operation 1 is a restricted operation, the policy may be implemented by withholding a valid physical address required for performing the configuration operation 1. With such a policy, the valid physical address cannot be found, so that the configuration operation corresponding to the valid physical address cannot be performed. Withholding the valid physical address may refer to refuse to provide the valid physical address of the target resource in an address list providing valid physical addresses of one or more target resources.

Besides detecting the requests for restricted configuration operations to target resources, the hypervisor 520 may further participate in job submission. For example, the hypervisor 520 may receive a job submission, downgrade the job submission to a de-privileged level, such that the job submission is acceptable in the non-secure domain and is unacceptable in the secure domain. The downgrading of the job submission may eliminate the need for it to pass through secure domain 540, thereby enhancing the security of the secure domain. Furthermore, the hypervisor 520 may send the downgraded job submission to a module in the non-secure domain to execute the job.

To enforce isolation of the secure domain or the target resources, access to privileged MMIO regions and configuration registers, which may be some examples of performing configuration operations, may be blocked at the hardware level using Intel® VT-d and Extended Page Tables (EPT). The non-secure domain may be explicitly limited to VF-level operations and may be prevented from accessing PF-level configuration spaces, even for the PF logically associated with it. Any unauthorized access attempts may be intercepted and denied through EPT enforcement and the PF DC's proxy mechanism.

By dividing the PF driver responsibilities between the secure domain and non-secure domain, delegating privileged control to the PF DC and restricting the KMD to basic operational roles, this architecture may ensure that critical resources such as DMA paths, MMIO mappings, interrupt controls, and configuration logic remain within the trusted boundary. The VF driver in the non-secure domain may retain only the minimal capability needed to perform job submissions through its assigned VF interface. Workloads submitted from all domains, including host environments, may be automatically downgraded to VF-level privilege.

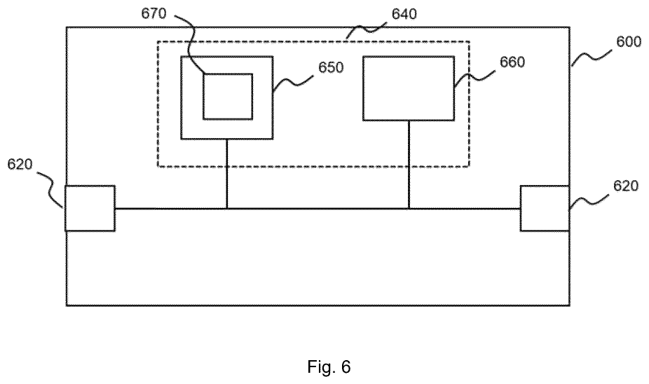

FIG. 6 illustrates a block diagram of apparatus 600 of an example of the application.

In some examples, apparatus 600 may include interfaces 620, such as 620a and 620b, and processing circuitry 640. Apparatus 600 may be configured to implement, based on the cooperations between one or more tangible computer-readable (“machine-readable”) non-transitory storage medium 650 and one or more processors 660 of the processing circuitry 640, operations and/or functionalities described with reference to the FIGS. 2, 3, 4 and/or 5. For example, the operations and/or functionalities may include each and every operation of method 200, method 300 and/or method 400 and may further include each and every operation made by modules in FIG. 5. The storage medium 650 may include all the machine-readable instructions for implementing methods 200, 300 and 400, and each and every module included in FIG. 5. In some examples, medium may refer to memory or media.

In some examples, apparatus 600 may perform the above implementations when the computer-executable instructions, such as the logic or computer program 670, are executed by one or more processors 660. In some examples, the interfaces 620 are interface means 620 and the processing circuitry 640 is processing means 640.

In some examples, the interfaces 620 may be configured to communicate with other apparatuses. In some examples, interfaces 620 may include one or more wireless interfaces including antennas, such as MIMO antennas, and/or wired interfaces, such as USB serial interfaces and/or RJ45 interfaces. The wireless interfaces may be configured to transmit and/or receive Wi-Fi signals, 3GPP signals and/or other wireless signals. The wired interfaces may be configured to receive signals transmitted via fiber, coaxial cables and other mediums.

In some examples, one or more processors 660 may be General Purpose CPUs, Mobile Processors, Server and Data Center Processors, Embedded Processors, Graphics Processing Units (GPUs), Specialized Processors, Microcontrollers, Field-Programmable Gate Arrays (FPGAs), Digital Signal Processors (DSPs), application-specific integrated circuits (ASICs), integrated circuits (ICs) and/or other circuitries having the capability of performing the operations of the controller in each and every example of this disclosure.

In some examples, the phrase “computer-readable non-transitory storage medium” may be directed to include all machine and/or computer readable medium, with the sole exception being a transitory propagating signal.

In some examples, the storage medium 650 may include one or more types of computer-readable storage medium capable of storing data, including volatile memory, non-volatile memory, removable or non-removable memory, erasable or non-erasable memory, writeable or re-writeable memory, and the like. For example, storage medium 650 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some examples, the logic or computer program 670 may include instructions, data, and/or code, which, if executed by a machine, such as implemented by one or more processors in an apparatus, may cause the machine to perform a method, process, and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some examples, each of components 620, 640, 650, 660 and 670 in the apparatus 600 may be implemented by a corresponding means capable of implementing the functions of the above components. In some examples, storage media 650 is not included in apparatus 600 because processors 660 may read logic or computer program 670 from a storage media out of the apparatus 600.

In some examples, the logic or computer program 670 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

In some examples, interfaces 620, storage media 650 and processors 660 communicate with each other via bus. In some other examples, some of these entities have direct communicative connections with each other.

In the following, some examples of the application are presented.

An example (e.g., example 1) relates to a non-transitory machine-readable storage medium including program code, when executed, to cause a machine to implement a trusted driver module in a secure domain. The trusted driver module is configured to determine that a non-secure domain requests a configuration operation on a target resource. Furthermore, it is configured to perform the configuration operation on the target resource upon determining that the configuration operation requested by the non-secure domain is permissible, wherein the secure domain is configured such that the resource protected by the secure domain is free from attacks by an agent external to the trusted driver module.

An example (e.g., example 2). relates to a previously described example (e.g., example 1) or to any of the examples described herein, where the trusted driver module is configured to identify the target resource as protected based on information retrieved from a firmware table.

An example (e.g., example 3) relates to a previously described example (e.g., example 2 or 3) or to any of the examples described herein, where the secure domain comprises a secure kernel hosting a trusted driver component.

An example (e.g., example 4) relates to a previously described example (e.g., any one of examples 1 to 3) or to any of the examples described herein, where the non-secure domain comprises an operating system kernel hosting one or more untrusted driver modules.

An example (e.g., example 5) relates to a previously described example (e.g., any one of examples 1 to 4) or to any of the examples described herein, where the trusted driver module is configured to determine that the configuration operation is requested by an untrusted driver module in the non-secure domain and perform the configuration operation as a proxy for the untrusted driver module in the non-secure domain.

An example (e.g., example 6) relates to a previously described example (e.g., any one of examples 1 to 5) or to any of the examples described herein, where the trusted driver module is configured to perform the configuration operation as if it were an original requester of the configuration operation.

An example (e.g., example 7) relates to a previously described example (e.g., any one of examples 1 to 6) or to any of the examples described herein, where the trusted driver module is configured to make a determination on whether the configuration operation on the target resource is permissible.

An example (e.g., example 8) relates to a previously described example (e.g., example 7) or to any of the examples described herein, where the determination is based on at least one of an identification of a module residing in the non-secure domain and requesting the configuration operation, a type of the target resource, a type of the configuration operation, or a current state of the target resource.

An example (e.g., example 9) relates to a previously described example (e.g., any one of examples 1 to 8) or to any of the examples described herein, where the configuration operation on the target resource comprises at least one of setting up the target resource, tearing down the target resource, or modifying a parameter of the target resource.

An example (e.g., example 10) relates to a previously described example (e.g., any one of examples 1 to 9) or to any of the examples described herein, where the trusted driver module is configured to deny the configuration operation on the target resource upon determining that the configuration operation requested by the non-secure domain is impermissible.

An example (e.g., example 11) relates to a previously described example (e.g., any one of examples 1 to 10) or to any of the examples described herein, where the trusted driver module is configured to receive a request for the configuration operation from an untrusted driver module in the non-secure domain via a privileged path.

An example (e.g., example 12) relates to a non-transitory machine-readable storage medium including program code, when executed, to cause a machine to implement a controlling module. The controlling module is configured to determine that a non-secure domain requests a restricted configuration operation on a target resource protected by a secure domain. Furthermore, it is configured to notify an untrusted driver module in the non-secure domain that the restricted configuration operation is requested by the non-secure domain.

An example (e.g., example 13) relates to a previously described example (e.g., example 12) or to any of the examples described herein, where the restricted configuration operation is determined based on a policy restricting the configuration operation on the target resource.

An example (e.g., example 14) relates to a previously described example (e.g., any one of examples 12 to 13) or to any of the examples described herein, where the policy is implemented by withholding a valid physical address of the target resource required to perform the configuration operation.

An example (e.g., example 15) relates to a previously described example (e.g., any one of examples 12 to 14) or to any of the examples described herein, where the controlling module is configured to receive a request for the configuration operation on the target resource from a requesting module in the non-secure domain.

An example (e.g., example 16) relates to a previously described example (e.g., any one of examples 12 to 15) or to any of the examples described herein, where the controlling module is configured to receive a job submission, downgrade the job submission to a de-privileged level such that the job submission is acceptable in the non-secure domain and is unacceptable in the secure domain, and send the downgraded job submission to a module in the non-secure domain to execute the job.

An example (e.g., example 17) relates to a previously described example (e.g., any one of examples 12 to 16) or to any of the examples described herein, where the controlling module is a hypervisor configured to create the secure domain and the non-secure domain.

An example (e.g., example 18) relates to a non-transitory machine-readable storage medium including program code, when executed, to cause a machine to implement an untrusted driver module in a non-secure domain. The untrusted driver module is configured to obtain a request for configuration operation on a target resource and send the request to a trusted driver module in a secure domain.

An example (e.g., example 19) relates to a previously described example (e.g., example 18) or to any of the examples described herein, where the untrusted driver module is configured to receive a job submission, downgrade the job submission to a de-privileged level such that the job submission is acceptable in the non-secure domain and is unacceptable in the secure domain, and send the downgraded job submission to a module in the non-secure domain to execute the job.

An example (e.g., example 20) relates to a previously described example (e.g., example 18 or 19) or to any of the examples described herein, where the untrusted driver module is configured to send the request to the trusted driver module in the secure domain via a privileged path.

An example (e.g., example 21) relates to a method, such as method 200. The method comprises determining that a non-secure domain requests a configuration operation on a target resource. Furthermore, the method comprises performing the configuration operation on the target resource upon determining that the configuration operation requested by the non-secure domain is permissible, where the secure domain is configured such that the resource protected by the secure domain is free from attacks by an agent external to the trusted driver module.

An example (e.g., example 22) relates to a previously described example (e.g., example 21) or to any of the examples described herein, where the method comprises identifying the target resource as protected based on information retrieved from a firmware table.

An example (e.g., example 23) relates to a previously described example (e.g., example 22) or to any of the examples described herein, where the method comprises hosting a trusted driver component in a secure kernel of the secure domain.

An example (e.g., example 24) relates to a previously described example (e.g., any one of examples 21 to 23) or to any of the examples described herein, where the method comprises hosting one or more untrusted driver modules in an operating system kernel of the non-secure domain.

An example (e.g., example 25) relates to a previously described example (e.g., any one of examples 21 to 24) or to any of the examples described herein, where the method comprises determining that the configuration operation is requested by an untrusted driver module in the non-secure domain and performing the configuration operation as a proxy for the untrusted driver module in the non-secure domain.

An example (e.g., example 26) relates to a previously described example (e.g., any one of examples 21 to 25) or to any of the examples described herein, where the method comprises performing the configuration operation as if the trusted driver module were an original requester of the configuration operation.

An example (e.g., example 27) relates to a previously described example (e.g., any one of examples 21 to 26) or to any of the examples described herein, where the method comprises making a determination on whether the configuration operation on the target resource is permissible.

An example (e.g., example 28) relates to a previously described example (e.g., example 27) or to any of the examples described herein, where the determination is based on at least one of an identification of a module residing in the non-secure domain and requesting the configuration operation, a type of the target resource, a type of the configuration operation, or a current state of the target resource.

An example (e.g., example 29) relates to a previously described example (e.g., any one of examples 21 to 28) or to any of the examples described herein, where the configuration operation on the target resource comprises at least one of setting up the target resource, tearing down the target resource, or modifying a parameter of the target resource.

An example (e.g., example 30) relates to a previously described example (e.g., any one of examples 21 to 29) or to any of the examples described herein, where the method comprises denying the configuration operation on the target resource upon determining that the configuration operation requested by the non-secure domain is impermissible.

An example (e.g., example 31) relates to a previously described example (e.g., any one of examples 21 to 30) or to any of the examples described herein, where the method comprises receiving a request for the configuration operation from an untrusted driver module in the non-secure domain via a privileged path.

An example (e.g., example 32) relates to a method, such as method 300. The method comprises determining that a non-secure domain requests a restricted configuration operation on a target resource protected by a secure domain. Furthermore, the method comprises notifying an untrusted driver module in the non-secure domain that the restricted configuration operation is requested by the non-secure domain.

An example (e.g., example 33) relates to a previously described example (e.g., example 32) or to any of the examples described herein, where the restricted configuration operation is determined based on a policy restricting the configuration operation on the target resource.

An example (e.g., example 34) relates to a previously described example (e.g., any one of examples 32 to 33) or to any of the examples described herein, where the policy is implemented by withholding a valid physical address of the target resource required to perform the configuration operation.

An example (e.g., example 35) relates to a previously described example (e.g., any one of examples 32 to 34) or to any of the examples described herein, where the method comprises receiving a request for the configuration operation on the target resource from a requesting module in the non-secure domain.

An example (e.g., example 36) relates to a previously described example (e.g., any one of examples 32 to 35) or to any of the examples described herein, where the method comprises receiving a job submission, downgrading the job submission to a de-privileged level such that the job submission is acceptable in the non-secure domain and is unacceptable in the secure domain, and sending the downgraded job submission to a module in the non-secure domain to execute the job.

An example (e.g., example 37) relates to a previously described example (e.g., any one of examples 32 to 36) or to any of the examples described herein, where the method comprises creating the secure domain and the non-secure domain using a hypervisor as the controlling module.

An example (e.g., example 38) relates to a method, such as method 400. The method comprises obtaining a request for a configuration operation on a target resource and sending the request to a trusted driver module in a secure domain.

An example (e.g., example 39) relates to a previously described example (e.g., example 38) or to any of the examples described herein, where the method comprises receiving a job submission, downgrading the job submission to a de-privileged level such that the job submission is acceptable in the non-secure domain and is unacceptable in the secure domain, and sending the downgraded job submission to a module in the non-secure domain to execute the job.

An example (e.g., example 40) relates to a previously described example (e.g., example 38 or 39) or to any of the examples described herein, where the method comprises sending the request to the trusted driver module in the secure domain via a privileged path.

An example (e.g., example 41) relates to an apparatus comprising a non-transitory machine-readable storage medium and one or more processors configured to implement a trusted driver module in a secure domain. The trusted driver module is configured to determine that a non-secure domain requests a configuration operation on a target resource. Furthermore, the trusted driver module is configured to perform the configuration operation on the target resource upon determining that the configuration operation requested by the non-secure domain is permissible, where the secure domain is configured such that the resource protected by the secure domain is free from attacks by an agent external to the trusted driver module.

An example (e.g., example 42) relates to a previously described example (e.g., example 41) or to any of the examples described herein, where the trusted driver module is configured to identify the target resource as protected based on information retrieved from a firmware table.

An example (e.g., example 43) relates to a previously described example (e.g., example 42) or to any of the examples described herein, where the secure domain comprises a secure kernel hosting a trusted driver component.

An example (e.g., example 44) relates to a previously described example (e.g., any one of examples 41 to 43) or to any of the examples described herein, where the non-secure domain comprises an operating system kernel hosting one or more untrusted driver modules.

An example (e.g., example 45) relates to a previously described example (e.g., any one of examples 41 to 44) or to any of the examples described herein, where the trusted driver module is configured to determine that the configuration operation is requested by an untrusted driver module in the non-secure domain and perform the configuration operation as a proxy for the untrusted driver module in the non-secure domain.

An example (e.g., example 46) relates to a previously described example (e.g., any one of examples 41 to 45) or to any of the examples described herein, where the trusted driver module is configured to perform the configuration operation as if it were an original requester of the configuration operation.

An example (e.g., example 47) relates to a previously described example (e.g., any one of examples 41 to 46) or to any of the examples described herein, where the trusted driver module is configured to make a determination on whether the configuration operation on the target resource is permissible.

An example (e.g., example 48) relates to a previously described example (e.g., example 47) or to any of the examples described herein, where the determination is based on at least one of an identification of a module residing in the non-secure domain and requesting the configuration operation, a type of the target resource, a type of the configuration operation, or a current state of the target resource.

An example (e.g., example 49) relates to a previously described example (e.g., any one of examples 41 to 48) or to any of the examples described herein, where the configuration operation on the target resource comprises at least one of setting up the target resource, tearing down the target resource, or modifying a parameter of the target resource.

An example (e.g., example 50) relates to a previously described example (e.g., any one of examples 41 to 49) or to any of the examples described herein, where the trusted driver module is configured to deny the configuration operation on the target resource upon determining that the configuration operation requested by the non-secure domain is impermissible.

An example (e.g., example 51) relates to a previously described example (e.g., any one of examples 41 to 50) or to any of the examples described herein, where the trusted driver module is configured to receive a request for the configuration operation from an untrusted driver module in the non-secure domain via a privileged path.

An example (e.g., example 52) relates to an apparatus comprising a non-transitory machine-readable storage medium and one or more processors configured to implement a controlling module. The controlling module is configured to determine that a non-secure domain requests a restricted configuration operation on a target resource protected by a secure domain. Furthermore, the controlling module is configured to notify an untrusted driver module in the non-secure domain that the restricted configuration operation is requested by the non-secure domain.

An example (e.g., example 53) relates to a previously described example (e.g., example 52) or to any of the examples described herein, where the restricted configuration operation is determined based on a policy restricting the configuration operation on the target resource.

An example (e.g., example 54) relates to a previously described example (e.g., any one of examples 52 to 53) or to any of the examples described herein, where the policy is implemented by withholding a valid physical address of the target resource required to perform the configuration operation.

An example (e.g., example 55) relates to a previously described example (e.g., any one of examples 52 to 54) or to any of the examples described herein, where the controlling module is configured to receive a request for the configuration operation on the target resource from a requesting module in the non-secure domain.

An example (e.g., example 56) relates to a previously described example (e.g., any one of examples 52 to 55) or to any of the examples described herein, where the controlling module is configured to receive a job submission, downgrade the job submission to a de-privileged level such that the job submission is acceptable in the non-secure domain and is unacceptable in the secure domain, and send the downgraded job submission to a module in the non-secure domain to execute the job.

An example (e.g., example 57) relates to a previously described example (e.g., any one of examples 52 to 56) or to any of the examples described herein, where the controlling module is a hypervisor configured to create the secure domain and the non-secure domain.

An example (e.g., example 58) relates to an apparatus comprising a non-transitory machine-readable storage medium and one or more processors configured to implement an untrusted driver module in a non-secure domain. The untrusted driver module is configured to obtain a request for a configuration operation on a target resource and send the request to a trusted driver module in a secure domain.

An example (e.g., example 59) relates to a previously described example (e.g., example 58) or to any of the examples described herein, where the untrusted driver module is configured to receive a job submission, downgrade the job submission to a de-privileged level such that the job submission is acceptable in the non-secure domain and is unacceptable in the secure domain, and send the downgraded job submission to a module in the non-secure domain to execute the job.

An example (e.g., example 60) relates to a previously described example (e.g., example 58 or 59) or to any of the examples described herein, where the untrusted driver module is configured to send the request to the trusted driver module in the secure domain via a privileged path.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory machine-readable storage medium including program code, when executed, to cause a machine to implement a trusted driver module in a secure domain, wherein the trusted driver module is configured to:
determine that a non-secure domain requests a configuration operation on a target resource; and
perform the configuration operation on the target resource upon determining that the configuration operation requested by the non-secure domain is permissible, wherein the secure domain is configured such that the resource protected by the secure domain is free from attacks by an agent external to the trusted driver module.

2. The storage medium of claim 1, wherein the trusted driver module is configured to identify the target resource as protected based on information retrieved from a firmware table.

3. The storage medium of claim 1, wherein the secure domain comprises a secure kernel hosting a trusted driver component.

4. The storage medium of claim 1, wherein the non-secure domain comprises an operating system kernel hosting one or more untrusted driver modules.

5. The medium of claim 1, wherein the trusted driver module is configured to determine that the configuration operation is requested by an untrusted driver module in the non-secure domain and perform the configuration operation as a proxy for the untrusted driver module in the non-secure domain.

6. The medium of claim 1, wherein the trusted driver module is configured to perform the configuration operation as if it were an original requester of the configuration operation.

7. The medium of claim 1, wherein the trusted driver module is configured to make a determination on whether the configuration operation on the target resource is permissible.

8. The storage medium of claim 7, wherein the determination is based on at least one of an identification of a module residing in the non-secure domain and requesting the configuration operation, a type of the target resource, a type of the configuration operation, or a current state of the target resource.

9. The storage medium of claim 1, wherein the configuration operation on a target resource comprises at least one of setting up the target resource, tearing down the target resource, or modifying a parameter of the target resource.

10. The storage medium of claim 1, wherein the trusted driver module is configured to deny the configuration operation on the target resource upon determining that the configuration operation requested by the secure domain is impermissible.

11. The storage medium of claim 1, wherein the trusted driver module is configured to receive a request for the configuration operation from an untrusted driver module in the non-secure domain via a privileged path.

12. A non-transitory machine-readable storage medium including program code, when executed, to cause a machine to implement a controlling module, wherein the controlling module is configured to:
determine that a non-secure domain requests a restricted configuration operation on a target resource protected by a secure domain; and
notify an untrusted driver module in the non-secure domain that the restricted configuration operation is requested by the non-secure domain.

13. The storage medium of claim 12, wherein the restricted configuration operation is determined based on a policy restricting the configuration operation on the target resource.

14. The storage medium of claim 12, wherein the policy is implemented by withholding a valid physical address of the target resource required to perform the configuration operation.

15. The storage medium of claim 12, wherein the controlling module is configured to receive a request for the configuration operation on the target resource from a requesting module in the non-secure domain.

16. The storage medium of claim 12, wherein the controlling module is configured to:
receive a job submission;
downgrade the job submission to a de-privileged level, such that the job submission is acceptable in the non-secure domain and is unacceptable in the secure domain; and
send the downgraded job submission to a module in the non-secure domain to execute the job.

17. The storage medium of claim 12, wherein the controlling module is a hypervisor configured to create the secure domain and the non-secure domain.

18. A non-transitory machine-readable storage medium including program code, when executed, to cause a machine to implement an untrusted driver module in a non-secure domain, wherein the untrusted module is configured to:
obtain a request for configuration operation on a target resource; and
send the request to a trusted driver module in a secure domain.

19. The storage medium of claim 18, wherein the untrusted driver module is configured to:
receive a job submission;
downgrade the job submission to a de-privileged level, such that the job submission is acceptable in the non-secure domain and is unacceptable in the secure domain; and
send the downgraded job submission to a module in the non-secure domain to execute the job.

20. The storage medium of claim 18, wherein the untrusted driver module is configured to:
send the request to the trusted driver module in the secure domain via a privileged path.
